(19) United States
(12) Patent Application Publication
(10) Pub. No.: US 2004/0018313 A1
(43) Pub. Date: Jan. 29, 2004

(54) Primer for painted metal used outdoors

(75) Inventor: James W. Otter, Fairfield Glade, TN (US)

Correspondence Address: WALL MARJAMA & BILINSKI, 101 SOUTH SALINA STREET, SUITE 400, SYRACUSE, NY, 13202, US

(73) Assignee: Carrier Corporation

(21) Appl. No.: 10/205,070

(22) Filed: Jul. 25, 2002

(51) Int. Cl. B05D 1/36

(52) U.S. Cl. 427/407.1

(57) ABSTRACT

A method of forming composite polymeric coatings on an outdoor metal substrate which includes providing an acidic starting solution which has at least one chemically distinct monomer and at least one solvent and where the monomer is polymerizable upon contact with the metal substrate. The monomer solution is applied to the substrate which will initiate spontaneous polymerization of the monomer on the surface of the metal substrate in the absence of any other catalyst or catalysts. The solution contacts the metal substrate for a time sufficient to form a polymeric coating on the substrate. The monomer further contains latent polymerization sites that do not react during spontaneous polymerization and are available as reaction sites for bonding with a later applied overcoating. A second decorative polymeric overcoat is applied to said first polymer coating whereby the latent polymerization sites react with said polymeric overcoat to enhance bonding and adhesion between the two coatings.

### FIELD OF THE INVENTION

The invention relates to metal parts and surfaces which are used outdoors, and more specifically for a polymeric primer for painted metal.

### BACKGROUND OF THE INVENTION

The current method FOR manufacturing metal outdoor parts, which are usually painted, is costly in that certain requirements regarding salt spray life ASTMB117 of about 500 hours require involved manufacturing procedure. There is a continuing need to improve standard salt spray life while reducing the cost of manufacturing parts requiring these properties. An objective in the prior art is to provide a continuous coating on a metal such as steel which in common practice is used for wire grills, to ensure that they have maximum outdoor life with respect to corrosion resistance. Technology relating to spontaneous polymerization appears to provide a viable technology to address this objective. This technology is adequately set forth and described in U.S. Pat. No. 5,807,612. The techniques set forth in U.S. Pat. No. 5,807,612 relate to a single coating layer which does not provide the necessary esthetic qualities and corrosion resistance for the outdoor parts under consideration. There is therefore a need for process and resulting products which utilizes the spontaneous polymerization advantages, and yet provide increased adhesion and corrosion resistance over that provide by the products formed by the U.S. Pat. No. 5,807,612 patent.

It is therefore an object of the present invention to provide a primer/adhesive coating for outdoor metal surface which overcomes the problems of the prior art described above.

It is a further object of the present invention to provide an improved protective coating for outdoor metal surfaces.

It is yet another object of the present invention to provide a corrosion resistant coating which is receptive to chemical bonding with a protective overlayer.

It is yet another object of the present invention to provide a composite coating system for outdoor metal surface surfaces which is low in VOC generation, and which can be efficiently and economically produced.

It is a further object of the present invention to provide a coating solution which is capable of undergoing spontaneous polymerization upon contact with a metal substrate which further contains latent polymerization sites that are capable for later reacting with an overcoating layer.

It is yet another object of the present invention to provide a spontaneous coating system for forming an initial protective coating on a metal surface which contains unreacted sites which are later reacted to cause polymerization with a second applied coating.

### SUMMARY OF THE INVENTION

In the present invention a continuous organic coating is applied to a metal substrate by spontaneous polymerization on all locations where it adheres to the substrate. The coating is made from a monomer or a blend of monomers containing different polymerization sites so that some of the monomers sites do not react during the spontaneous polymerization and are left over or latent for reacting at a later time, but are still part of the coating. At a later time when a second polymeric overcoating is coated over the initial coating for further protection, the above described unreacted sites are polymerized and function to adhere the two coatings together. The polymerization (S-poly process) of the first coating appears through spontaneous or auto-polymerization and is more fully described by U.S. Pat. No. 5,807,612 which is incorporated herein by reference. The second or top coating is an over laminate coat (“top coat”) which is used to increase the protection of the underlying metal which comprises the unreacted moieties or sites to improve adhesion between the two coatings.

The composition of the coating solution comprises an acidic solution of organic monomer, capable of undergoing spontaneous polymerization upon contact with the metal substrate such as steel, copper, aluminum and the like thereby forming an initial polymeric coating on the metal substrate. Spontaneous polymerization refers to the spontaneous polymerization of monomers upon exposure of the monomer solution to the metal substrate in an acidic solution such that electron transfer occurs, initiating polymerization of unsaturated sites on the monomers. The polymerization ordinarily proceeds at room temperature. Heat, however, maybe applied to the solution in order to increase the rate of polymerization or to effect the variation in the properties of the final coating. The preferred monomer solution is at least a two component solution, with a one component monomer solution is also being usable.

### BRIEF DESCRIPTION OF THE DRAWINGS

For a further understanding of these and objects of the invention, reference will be made to the following detailed description of the invention which is to be read in connection with the accompanying drawing, wherein:

FIG. 1 is a side sectional view of a composite protective coating for use on outdoor painted metal.

FIG. 2 is a schematic flow diagram illustrating one embodiment of a method of coating metal to be used outdoors.

FIG. 3 is a schematic flow diagram illustrating a second embodiment of a method of coating metal to be used outdoors.

### DETAILED DESCRIPTION OF THE INVENTION

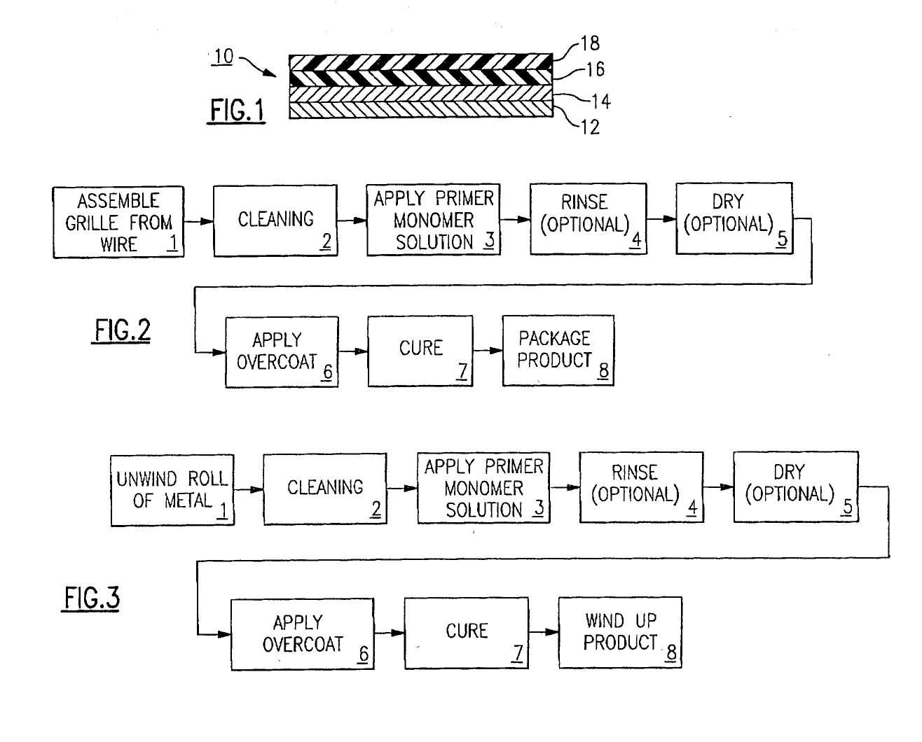

A continuous organic coating is applied to a metal substrate by spontaneous polymerization of the appropriate monomer or monomers, where it adheres. This coating is made from (a) monomer(s) containing differing polymerization sites so some monomers, or sites, do not react during the spontaneous polymerization and so are “left over” for reacting later, but are still a part of the coating. As well, the monomers may contain moieties that do not react during spontaneous polymerization but are available for reaction with the overcoat, for instance, a carboxyl, a hydroxyl or an amide group. If needed or desired, mixed in with the coating is an agent which will cause the unreacted site, or monomer, to react when either heat or a chemical accelerator used to cause polymerization of the second monomer or reactive site is applied. At a chosen time, a coating to increase protection, but more particularly, the appearance of the metal is applied. This coating may be any commercially available coating with the desired color and other esthetic qualities. with the desired weathering properties, and may be applied by an appropriate method commercial such as spray, powder coating, reverse roll coating, dipping, etc. Where there are heretofore unreacted moieties on the spontaneously polymerized coating, they polymerize with appropriate sites on the overcoat polymer, using an accelerator if desired, and adhesion to the two coatings is assured. If reactive sites are not available in the coating deposited by spontaneous polymerization, then this coating is left uncured to partially cured and the overcoat applied. If the overcoat is not compatible with water, the coating deposited by spontaneous polymerization must be dried, but normally it would be advisable to retain the cosolvent (n-methyl pyrrolidone is recommended, but others may well be used) to induce solvation of the overcoat at the interface. FIG. 1 is a schematic illustration of a composite laminate which illustrates the present invention. The composite 10 comprise a metal substrate 12, a galvanized layer (for steel) 14, a primer coating 16 and an esthetic overcoating 18.

Cure of both coatings is then induced and diffusion and wetting will assure intercoat adhesion. This will be accomplished by the use of spontaneous polymerization in a manner similar to, but not limited to, the method and practices in the attached literature. As well, one monomer with two reaction sites, where the functionality of the two sites on the same molecule, is similar, differing only in activation energy so that only the monomer with the lower activation energy forms a polymer during spontaneous polymerization, leaving the other monomer for a later reaction that causes the applied film to adhere. Also, the reactive sites could differ in reaction mechanism such that a coating of a polymer would be formed by reaction among the one type of moiety only, leaving the other free to react later by a different mechanism. The former could be accomplished by, for instance but not limited to, the use of vinyl and allyl moieties, either on separate monomers or as part of a single monomer, for instance but not limited to, the ester adduct of allyl alcohol and acrylic acid, or a mixture of such monomers, with a peroxide chain initiator of a type to induce reaction of the allyl groups not reacted during spontaneous polymerization admixed during spontaneous polymerization. The latter method, that of two moieties differing in reaction mechanism, could be achieved by, for instance but not limited to, an epoxy as one reactive moiety and a hydroxyl or amide group as the other. The single monomer with two differing reactive sites appears to be the better choice, but economics and the ease of making the monomer solution may dictate otherwise. Also, the attached literature cites the use of an inorganic acid to provide the electrons to initiate spontaneous polymerization. The use of zinc, a well-known protective layer on steel, is difficult because the inorganic acid causes the problem of hydrogen evolution. Buffering, to reduce and control acidity, or the use of a weak base (organic, such as an amine or inorganic such as ammonia), keeping a low concentration of monomer(s) and/or acid(s) and/or cooling the monomer solution could remove this barrier to the use of zinc-coated steel.

The composition of the coating solution comprises an acidic solution of organic monomer, capable of undergoing spontaneous polymerization upon contact with a metal substrate, thereby forming a polymeric coating on the metal substrate. “Spontaneous polymerization” refers to the spontaneous polymerization of monomers upon exposure of the monomer solution to the metal substrate in an acidic solution such that electron transfer occurs, initiating polymerization of unsaturated sites on the monomers. Polymerization ordinarily proceeds at room temperature. However, heat may be applied to the solution in order to increase the rate of polymerization, or to effect a variation in the properties of the final coating. Although the preferred monomer solution is at least a two-component solution, a one-component monomer solution is also potentially usable. Both monomers and small polymers, e.g., small molecules with one or more repeating units soluble in the solvent also may find application.

One preferred solution for use on steel comprises an acidic solution of methylmethacrylate (MMA) and 4-carboxyphenyl maleimide (4-CPMI). An acidic solution of 4-CPMI and acrylonitrile (AN), when used to coat steel, may also be used.

Other useful monomers capable of reacting in an autopolymerization mode by electron withdrawing include carbonyl, carboxyl, carboxylate, carboxamide, nitrile groups and the like, thio analogues of the oxygen-containing functional groups, acrylic acid, acrylamide, acrylonitrile, and alkyl acrylates in which the alkyl moiety contains 1 to 40 carbon atoms, phenyl acrylate and p-tolyl acrylate, cycloalkyl acrylates such as cyclohexyl acrylate, methacrylic acid, methacrylamide, methacrylonitrile, alkyl methacrylates.

Electron donating monomers are 1-alkenes such as ethylene, propylene and like unsaturated olefins, alpha-olephins containing aromatic substituents, especially styrene, acyclic or cyclic monoolefins, conjugated dienes such as butadiene, isoprene, propylene, 2,4-hexadiene. 1-Alkenes having substituents further removed from the double bond are also effective. In particular, allyl alcohol could provide the hydroxyl group in a primer for reaction with an overcoat.

A third and even a fourth monomer (or more)may be introduced into the monomer solution.

Process parameters which may be used to affect the final properties of the coatings include monomer concentration, metal surface pretreatment, polymerization time, and drying temperature.

An acidic monomer solution is provided, the clean metal substrate is submerged (dipped) into the monomer solution for a prescribed period of time. A “dried-in-place” (reverse) roll coating method may also be used, and in a production situation may be preferred, especially if coils of metal are to be coated.

No special surface treatments are necessary for the autopolymerization method. The only requirement is a clean surface, readily supplied by simple cleaning processes. The pH of the monomer solution may be adjusted using acids such as dilute sulfuric acid, hydrochloric acid, dilute nitric acid, acetic acid, phosphoric acid, and citric acid.

While not required, an accelerator may be added to the monomer solution to increase the reaction rate.

A number of economically important metals, including aluminum, iron, copper, steel, zinc, and alloys thereof may be coated.

Chemical modification of monomers cited in the patent to provide moieties that will not react during the S-poly process but will react with an overcoat of adhesive or paint is the method of choice. The moieties cited below are best to be pendant from the monomer molecule reacting in the S-poly formation of the primer coat in order that they would better be available for reaction with the reactive groups in the overcoat of adhesive or paint.

1. Electron Accepting Monomers.

Useful pendant groups capable of reacting with suitable groups on an applied overcoat include carboxyl. The carboxyl groups could be made more available for reacting with the overcoat of adhesive or paint than those in the cited patent (e. g., (meth) acryilic acid) by first forming the half-ester with a (long-chain) di-alcohol such as butane diol or higher molecular weight (longer chain) homologs, then reacting the available hydroxyl with an acid chloride group formed on a difunctional acid (e. g., phthalic or succinic (butanedioic) acid). The pendant carboxyls can react with alcohol moieties found in the overcoat of adhesive or paint.

Should the reaction immediately above be stopped at the point of esterification of one alcohol moiety on the difunctional alcohol, then the pendant hydroxyl group would be available for reaction with epoxy, carboxylic or isocyanate moieties.

The pendant carboxyls can be reacted with a primary amine, to produce an amide, that can react with epoxy or urethane moieties found in the overcoat of adhesive or paint.

The ratio of the above modified electron accepting monomers to electron donating monomers should be weighted in favor of the modified monomers. The literature cites a from a 95:5 to a 5:95 ratio of electron accepting monomers to electron donating monomers can be used. A ratio of modified electron accepting monomers to electron donating monomers giving the best properties would need to be ascertained, but it is likely that modified electron accepting monomers would be over 50% of the monomers, and likely more, to the limit of 95%.

2. Electron Donating Monomers.

An organic acid esterified with allyl alcohol (propen-1-ol) would produce a monomer with allyl (propenic) unsaturation, an electron donating group. Using a difunctional organic acid would allow chain extension and carboxy termination. The carboxy could be used without modification, or it could be amidized, or esterified with a diol ,to react with suitable groups on an applied overcoat.

3. Combination of Monomers

Using an acrylic compound as the electron accepting monomer, and propene as the electron donating monomer in the monomer solution, with appropriate adjustment of the ratio of these compounds to one another, a thermoplastic coating with a desirable melting point, i. e., 165 to 200 degrees Celsius, and the appropriate amount of olefin to induce adhesion to an olefin film (e. g., ethylene-propylene copolymer) could be produced. Adhesion to the film would be achieved by heating the coating to its melt point and applying the olefin film with sufficient pressure that adhesion between the liquefied coating and the film is achieved.

Since more than 2 monomers may be used in the monomer solution, choices among appropriate monomers to effect singular properties could be made.

4. Application

Common commercial methods of application of the monomer solution to a moving metal strip could be used. One of particular appeal is “dried-in-place” application, wherein the solution is applied by a metered (reverse) roll, then rinsed, if desired/required, then dried/cured. Spray and other methods of application may be used, but since the concentration of monomers is low, metered roll application appears to be the most desirable method.

FIG. 2 is flow diagram which illustrates the present invention where a number of wires are assembled, and welded, into a grille, which is coated with a primer by the S-poly method, then over coated to make the desired product, a corrosion-resistant strip of metal with the desired esthetic properties.

At Station 1, a number of wires made of metal of the desired alloy and diameter are assembled, welded and hung on a conveyor, which pulled along the path described.

At Station 2, the surface of the metal is cleaned, which likely would include an acid etch.

At Station 3, a controlled amount of the primer monomer solution, composed of selected electron donating and electron receiving monomers, is applied, here by dipping, or spray.

The surface polymerization occurs between Stations 3 and 4, depositing a film of primer polymer.

If desired, the deposited primer film may be rinsed at Station 4.

If desired, the deposited primer film may be dried at Station 5. It may even be cured, if so desired.

At Station 6, the overcoat is applied. It may be applied by any commercial method, or by a second S-poly process. In the latter event, Stations 4 and 5 would not exist.

At Station 7, the overcoat, and the primer coat if not previously cured, is/are cured.

At Station 8, the coated metal product is packaged for shipping.

FIG. 3 is a flow diagram which illustrates the present invention where a continuous coil (ribbon) f metal is coated with a primer by the s-poly method, then over coated to make the desired product, a corrosion-resistant strip of metal with the desired esthetic properties.

At station 1, a roll of metal of the desired alloy, thickness and width is unrolled and pulled along the path described at station 2, the surface of the metal is cleaned, which likely would include an acid etch.

At station 3, a controlled amount of the primer monomer solution, composed of selected electron donating and electron receiving monomers, is applied, here by the revers roll method.

The surface polymerization occurs between stations 3 and 4, depositing a film of primer polymer. If desired, the deposited primer film may be station 4.

If desired the deposited primer film may be dried at station 5. It may even be cured, if so desired.

At station 6, the overcoat is applied. It may be applied by any commercial method consistent with achieving the desired esthetic and corrosion resistant properties.

At station 7, the overcoat, and the primer coat if not previously cured, is/are cured.

At station 8, the coated metal product is wound up.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A method of forming composite polymeric coatings on a metal substrate which comprises:
providing an acidic starting solution which includes at least one chemically distinct monomer and at least one solvent wherein the at least one monomer is polymerizable upon contact with the metal substrate;
applying the monomer solution to said substrate wherein the metal substrate is a metal which will initiate spontaneous polymerization of said monomer on the surface of the metal substrate in the absence of other catalyst or catalysts; and contacting the metal substrate with said solution for a time sufficient to form a polymeric coating on the metal substrate, and wherein said monomer further contains latent polymerization sites that do not react during spontaneous polymerization and are available as reaction sites for bonding with a later applied ovecoating; and
applying a polymeric overcoat to said first polymer coating whereby said latent polymerization sites react with said polymeric overcoat to enhance bonding and adhesion between the two coatings.

2. The method of claim 1, wherein the pH of the starting solution is less than about 6.5.

3. The method of claim 2, wherein the pH of the starting solution is between about 6.5 and about 1.

4. The method of claim 1, wherein the pH of the starting solution is adjusted by the addition of at least one acid selected from the group consisting of dilute sulfuric acid, hydrochloric acid, dilute nitric acid, acetic acid, phosphoric acid, and citric acid.

5. The method of claim 1, wherein the at least one solvent is selected from the group consisting of benzene, toluene, chloroform, methylene chloride, hexane, acetone, tetrahydrofuran, acetonitrile, dimethyl formamide, dimethylacetamide, N-methyl-2-pyrrolidone, dimethyl sulfoxide, a hydrocarbon solvent, a halogenated solvent, an aromatic solvent, an oxygen-donating solvent, and mixtures of the foregoing with water.

6. The method of claim 1, wherein the metal substrate is a metal selected from the group consisting of aluminum, copper, iron, steel, zinc and alloys thereof.

7. The method of claim 1, wherein the monomer is one or more of the following: at least one monomer selected from the group consisting of 4-carboxymethyl maleimide and styrene; and at least one additional monomer selected from the group consisting of N-phenyl maleimide, 2-(methyacryloyloxy)ethyl acetoacetate, bis-maleimide, methyl methacrylate, 4-carboxymethyl maleimide, and acrylonitrile.

8. The method of claim 1, wherein the monomer solution includes at least one electron acceptor monomer having at least one electron withdrawing group; and at least one electron donor monomer having at least one electron donating group.

9. The method of claim 8 in which the electron accepting monmer further includes a carboxyl pendant group which is capable of reacting with an applied overcoat, and where the electron donating monomer contains a difunctional organic acid which functions to react with an applied overcoat.
